(19) United States
(12) Patent Application Publication
(10) Pub. No.: US 2026/0138499 A1
(43) Pub. Date: May 21, 2026

(54) Method and Device for Optimizing Battery Temperature Before Driving Vehicle

(71) Applicants: Hyundai Motor Company, Seoul (KR); Kia Corporation, Seoul (KR)

(72) Inventor: Myoung Kyou Lee, Hwaseong-Si (KR)

(21) Appl. No.: 19/227,652

(22) Filed: Jun. 4, 2025

(30) Foreign Application Priority Data
Nov. 19, 2024 (KR) 10-2024-0165599

(51) Int. Cl. B60L 58/26; B60L 58/12; H01M 10/613; H01M 10/625; H01M 10/635

(52) U.S. Cl. CPC B60L 58/26; B60L 58/12; H01M 10/613; H01M 10/625; H01M 10/635; B60L 2240/545; B60L 2240/662; B60L 2260/52; B60L 2260/54

(57) ABSTRACT

An apparatus configured to communicate with a vehicle may perform a method comprising determining, before driving the vehicle, whether a state of charge (SoC) of a battery of the vehicle satisfies a threshold SoC value. Based on a determination that the SoC satisfies the threshold SoC value, the apparatus determines an indicator indicating a predicted operating performance of the vehicle associated with overheating of the battery. Based on driving information of a driver of the vehicle, battery information, and the indicator, the apparatus generates a signal indicating a recommended mode of the vehicle and a target battery temperature of the battery. The signal is then transmitted to the vehicle.

### CROSS-REFERENCE TO THE RELATED APPLICATION

The present application claims the benefit of priority under 35 U.S.C 119 from Korean Patent Application No. 10-2024-0165599, filed on Nov. 19, 2024 in the Korean Intellectual Property Office, the disclosure of which is incorporated herein by reference in its entirety.

### 1. TECHNICAL FIELD

The present disclosure relates to an eco-friendly vehicle, and more specifically, to a method and device for optimizing battery temperature before driving a vehicle.

### 2. BACKGROUND

The matters described in this Background section are only for enhancement of understanding of the background of the disclosure, and should not be taken as acknowledgment that they correspond to prior art already known to those skilled in the art.

Eco-friendly vehicles such as hybrid electric vehicles (HEVs), plug-in HEVs (PHEVs), and electric vehicles (EVs) may have a built-in battery, which is a storage device for storing electrical energy, to drive a motor, and in particular, have a built-in high-voltage battery that is different from a low-voltage battery in internal combustion engine vehicles. Such a high-voltage battery may include a plurality of unit cells inside and may be manufactured in a module form in which a pair of external terminal tabs connected to electrodes of each cell is exposed to the outside.

In summer and when exposed to extreme heat, the battery of a vehicle may overheat to a high temperature, which may result in the vehicle not being able to realize the full performance thereof upon being driven.

In addition, some drivers may want to drive their vehicles at maximum performance immediately after departure rather than in an energy-efficient manner considering the driving range, and thus the requirements for the battery temperature before departure may vary depending on the user.

However, there is no technology for precooling a high-temperature battery before driving a vehicle.

Therefore, in the present technical field, a new technology is considered to pre-optimize a high battery temperature before driving a vehicle in consideration of a driving pattern or preference of a driver.

### SUMMARY

Therefore, the present disclosure has been made in view of the above problems, and it is an object of the present disclosure to provide technology for pre-optimizing a high battery temperature before driving a vehicle in consideration of a driving pattern or preference of a driver.

According to the present disclosure, a method performed by an apparatus configured to communicate with a vehicle may comprise before driving the vehicle, determining, by the apparatus, whether a state of charge (SoC) of a battery of the vehicle satisfies a threshold SoC value, based on a determination that the SoC of the battery satisfies the threshold SoC value, determining, by the apparatus, an indicator indicating a predicted operating performance of the vehicle associated with overheating of the battery, based on driving information of a driver of the vehicle, battery information, and the indicator, generating a signal indicating a recommended mode of the vehicle and a target battery temperature of the battery, and transmitting the signal to the vehicle.

The method, wherein the determining the indicator may comprise determining, based on a temperature of the battery being equal to or higher than a threshold temperature or based on a reference temperature associated with a current weather condition, the indicator indicating the predicted operating performance of the vehicle associated with overheating of the battery.

The method, wherein the determining whether the SoC of the battery satisfies the threshold SoC value may comprise determining output statistics associated with the battery, determining a state of energy (SoE) estimation value of the battery after cooling the battery by deducting a predicted energy usage value during cooling operation from a measured SoE associated with the battery, determining a driving range of the vehicle based on the output statistics and the SoE estimation value after cooling the battery, and before driving the vehicle, determining, based on the driving range of the vehicle, whether the SoC of the battery is sufficient to drive the vehicle.

The method, wherein the output statistics are determined based on an average of power usage of the vehicle operating in urban areas and an average of power usage of the vehicle operating in highway areas.

The method, wherein the average of power usage in urban areas is determined based on an average power usage of the vehicle operating at or below an urban area standard speed, and an average power usage of the vehicle operating at or above the urban area standard speed.

The method, wherein the average of power usage in highway areas is determined based on an average power usage of the vehicle operating at or below a highway area standard speed, and an average power usage of the vehicle operating at or above the highway area standard speed.

The method, wherein the generating the signal may comprise determining a resistance associated with the battery based on a current temperature of the battery, a current SoC of the battery, and a current state of health (SoH) of the battery, determining an amount of battery temperature increase based on an average current associated with the battery and the resistance associated with the battery, determining a temperature margin based on weather conditions and driving habits of the driver of the vehicle, wherein the driving habits are associated with an acceleration of the vehicle, and determining the indicator indicating the predicted operating performance of the vehicle associated with overheating of the battery based on the current temperature of the battery, the amount of battery temperature increase, and the temperature margin.

The method, wherein the recommended mode and the target battery temperature, before driving the vehicle, are determined based on at least one of an average driving mode of the driver, an average driving speed of the driver when the driver is driving in urban areas, an average driving speed of the driver when the driver is driving in highway areas, road usage habits of the driver, or a recommended route for a destination set by the driver.

According to the present disclosure, an apparatus configured to communicate with a vehicle, the apparatus may comprise a processor, and a memory storing at least one instruction that, when executed by the processor communicating with the memory, is configured to cause the apparatus to before driving the vehicle, determine whether a state of charge (SoC) of a battery of a vehicle satisfies a threshold SoC value, determine, based on a determination that the SoC of the battery satisfies the threshold SoC value, an indicator indicating a prediction of a predicted operating performance of the vehicle associated with overheating of the battery, based on driving information of a driver of the vehicle, battery information, and the indicator, generate a signal indicating a recommended mode of the vehicle and a target battery temperature of the battery, and transmit the signal to the vehicle.

The apparatus, wherein the at least one instruction, when executed by the processor communicating with the memory, is configured to cause the apparatus to determine, based on a temperature of the battery being equal to or higher than a threshold temperature or based on a reference temperature associated with a current weather condition, the predicted operating performance of the vehicle associated with overheating of the battery.

The apparatus, wherein the at least one instruction, when executed by the processor communicating with the memory, is configured to cause the apparatus to determine output statistics associated with the battery, determine a state of energy (SoE) estimation value of the battery after cooling the battery by deducting a predicted energy usage value during cooling operation from a measured SoE associated with the battery, determine a driving range of the vehicle based on the output statistics and the SoE estimation value after cooling the battery, and before driving the vehicle, determine, based on the driving range of the vehicle, whether the SoC of the battery is sufficient to drive the vehicle.

The apparatus, wherein the output statistics are determined based on an average of power usage of the vehicle operating in urban areas, and an average of power usage of the vehicle operating in highway areas.

The apparatus, wherein the average of power usage of the vehicle operating in urban areas is determined based on an average power usage of the vehicle operating at or below an urban area standard speed, and an average power usage of the vehicle operating at or above the urban area standard speed.

The apparatus, wherein the average of power usage in highway areas is determined based on an average power usage of the vehicle operating at or below a highway area standard speed, and an average power usage of the vehicle operating at or above the highway area standard speed.

The apparatus, wherein the at least one instruction, when executed by the processor communicating with the memory, is configured to cause the apparatus to determine a resistance associated with the battery based on a current temperature of the battery, a current SoC of the battery, and a current state of health (SoH) of the battery, determine an amount of battery temperature increase based on an average current associated with the battery and the resistance associated with the battery, determine a temperature margin based on an weather conditions and driving habits of the driver of the vehicle, wherein the driving habits are associated with an acceleration of the vehicle, and determine the indicator indicating the predicted operating performance of the vehicle associated with overheating of the battery based on the current temperature of the battery, the amount of battery temperature increase, and the temperature margin.

The apparatus, wherein the recommended mode and the target battery temperature, before driving the vehicle, are determined based on at least one of an average driving mode of the driver, an average driving speed of the driver when the driver is driving in urban areas, an average driving speed of the driver when the driver is driving in highway areas, road usage habits of the driver, or a recommended route for a destination set by the driver.

According to the present disclosure, a method performed by an apparatus of a vehicle may comprise transmitting, to a device, data associated with the vehicle, wherein the data may comprise a state of charge (SoC) of a battery of the vehicle and a temperature of the battery, determining, based on a battery cooling condition being satisfied, an operation mode of the vehicle and a target temperature of the battery, adjusting, based on the target temperature, the temperature of the battery before driving the vehicle, and driving the vehicle based on the operation mode after the temperature of the battery reaches the target temperature.

The method, wherein the operation mode may comprise one of a sport mode, an eco mode, an off-road mode, a long-range mode, or a highway mode.

The method may further comprise receiving, from a connected charger, power for charging the battery and cooling the battery until the temperature of the battery reaches the target temperature.

The method, wherein the battery cooling condition may comprise at least one of a user permission for cooling the battery using power supplied from a connected charger, the operation mode of the vehicle, or driving habits of a driver of the vehicle.

According to the present disclosure, a method performed by a server may comprise determining, based on a state of charge (SoC) of a battery of a vehicle satisfying a threshold SoC value, whether to perform cooling of the battery before driving the vehicle, generating, based on the determining, a signal indicating an operation mode of the vehicle and a target temperature of the battery, and transmitting the signal to the vehicle.

The method, wherein the determining whether to perform cooling of the battery before driving the vehicle may comprise determining, based on a temperature of the battery exceeding a threshold temperature and current weather conditions surrounding the vehicle, whether to perform the cooling of the battery.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 shows an example of a configuration of a battery temperature optimization server according to an example of the present disclosure;

FIG. 2 shows an example of a query screen regarding whether to perform battery preconditioning according to an example of the present disclosure;

FIG. 3 shows an example of a query screen regarding whether to perform battery precooling depending on a result of analysis of customer's driving habits according to an example of the present disclosure;

FIG. 4 shows an example of a battery temperature optimization method according to an example of the present disclosure;

FIG. 5 shows an example of a signal transmission/reception relationship between a server, a vehicle, a battery research institute, and an automobile research institute according to an example of the present disclosure;

FIG. 6 shows an example of step S405 of FIG. 4 in detail;

FIG. 7 shows an example of step S420 of FIG. 4 in detail; and

FIG. 8 shows an example of step S435 of FIG. 4 in more detail.

### DETAILED DESCRIPTION

Specific structural and functional descriptions of the examples of the present disclosure, disclosed in the present specification or application, are merely illustrative for the purpose of explaining the examples according to the present disclosure, and the examples according to the present disclosure may be implemented in various forms and should not be construed as being limited to the examples described in this specification or application.

Since the examples according to the present disclosure can be modified in various manners and have various forms, specific examples will be illustrated in the drawings and described in detail in the specification or application. However, this is not intended to limit the examples according to the concept of the present disclosure to a specific disclosed form, and should be understood to include all changes, equivalents, and substitutes included in the spirit and technical scope of the present disclosure.

All terms including technical or scientific terms have the same meanings as generally understood by a person having ordinary skill in the art to which the present disclosure pertains unless mentioned otherwise. Generally used terms, such as terms defined in a dictionary, should be interpreted to coincide with meanings of the related art from the context. Unless differently defined in the present disclosure, such terms should not be interpreted in an ideal or excessively formal manner.

Hereinafter, examples disclosed in the present specification will be described in detail with reference to the attached drawings. However, identical or similar components will be assigned the same reference numeral, and redundant descriptions thereof will be omitted.

In the description of the following examples, the term “preset” means that the value of a parameter is predetermined when the parameter is used in a process or an algorithm. Depending on examples, the value of a parameter may be set when a process or an algorithm starts or may be set during a period in which the process or the algorithm is performed.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

In the present disclosure, the “system” may include at least one device among a computing device, a network device, a controller, a vehicle device, a server device, and/or a cloud device, but is not limited thereto. For example, the system may include (or configured with) one or more server devices. As another example, the system may include (or configured with) one or more cloud devices. As another example, the system may operate by a server device and a cloud device.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

In the following description of the examples disclosed in the present specification, a detailed description of known functions and configurations incorporated herein will be omitted when it may obscure the subject matter of the present disclosure. In addition, the accompanying drawings are provided only for ease of understanding of the examples disclosed in the present specification, do not limit the technical spirit disclosed herein, and include all changes, equivalents and substitutes included in the spirit and scope of the present disclosure.

The terms “first” and/or “second” are used to describe various components, but such components are not limited by these terms. The terms are used to discriminate one component from another component.

When a component is “coupled” or “connected” to another component, it should be understood that a third component may be present between the two components although the component may be directly coupled or connected to the other component. When a component is “directly coupled” or “directly connected” to another component, it should be understood that no element is present between the two components.

An element described in the singular form is intended to include a plurality of elements unless the context clearly indicates otherwise.

In the present specification, it will be further understood that the term “comprise” or “include” specifies the presence of a stated feature, figure, step, operation, component, part or combination thereof, but does not preclude the presence or addition of one or more other features, figures, steps, operations, components, or combinations thereof.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

In addition, a unit or a control unit included in names such as a motor control unit (MCU) and a hybrid control unit (HCU) is merely a term widely used in naming a control device that controls specific vehicle functions and does not mean a generic functional unit.

A controller may include a communication device that communicates with other controllers or sensors to control the functions of the controller, a memory that stores an operating system, logic instructions, input/output information, etc., and one or more processors that perform determination, computation, and decision used to control the functions.

According to one or more examples of the present disclosure, the challenge of battery overheating in electric vehicles (EVs) is addressed. When an EV is charged at a station and remains idle, its battery may retain heat, which may negatively impact performance and driving range. When cooling occurs after the vehicle starts, it may consume high-voltage battery power and further reduce available driving range, especially when air conditioning is also in use. The present disclosure proposes leveraging charging station power to pre-cool the battery before departure, ensuring optimal temperature without depleting driving energy. A smart system may determine cooling necessity by analyzing real-time data, for example, including vehicle charging status, ambient weather conditions, and/or driver behavior patterns, etc. This approach may allow efficient cooling tailored to individual driving habits, reducing energy loss and improving overall battery efficiency. Further, the system may collect and transmit battery performance data to research institutions and manufacturers, facilitating advancements in battery management and electric vehicle technology.

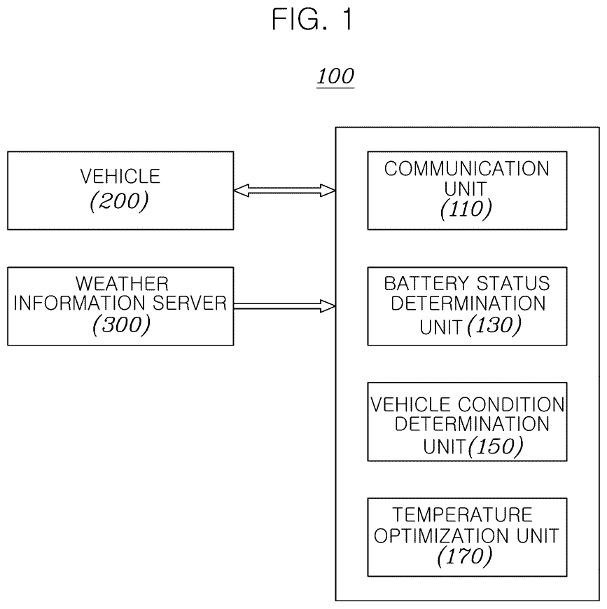

FIG. 1 shows an example of a configuration of a battery temperature optimization server according to an example of the present disclosure.

Referring to FIG. 1, the battery temperature optimization server 100 may include a communication unit 110 (e.g., a transceiver), a battery status determination unit 130 (e.g., a battery management circuitry, a temperature sensor arrays, impedance measurement circuit, a state of health (SoH) estimation circuit, etc.), a vehicle condition determination unit 150 (e.g., a vehicle telematics circuitry, a climate control monitoring circuitry, a powertrain control circuitry, a geolocation-based circuitry, etc.), and a temperature optimization unit 170 (e.g., a thermal management circuit, a heat pump, a pre-conditioning circuit, etc.).

The communication unit 110 may communicate with a vehicle 200 and/or a weather information server 300.

For example, the communication unit 110 may receive information on the current temperature and SoC (State of Charge), SoH (State of Health), voltage levels, or recent charging history of a battery from the vehicle 200 and transmit information on a battery temperature optimized for the vehicle 200.

In addition, the communication unit 110 may receive current weather information from the weather information server 300.

The current weather information may include at least one of the current temperature, humidity, precipitation, wind speed, solar radiation intensity, or a combination thereof.

The battery status determination unit 130 may determine whether the battery of the vehicle 200 uses precooling.

The battery status determination unit 130 may determine whether the battery of the vehicle 200 uses precooling based on the driver's driving pattern of the vehicle 200 (e.g., driver's historical driving behavior such as frequent rapid acceleration, long highway drives, or stop-and-go urban commutes, etc.), the current temperature of the battery, and/or expected temperature increase based on the weather forecast received from the weather information server 300.

The battery status determination unit 130 may determine a departure time of the vehicle using a reservation air conditioning setting of a reservation air conditioning system, a scheduled charging session, or navigation-based predictive departure analysis set by a user. Here, the battery status determination unit 130 may determine whether the vehicle 200 is expected to depart within a certain period of time from the present.

In addition, the battery status determination unit 130 may determine the average hourly usage of the battery based on the usual driving pattern of the user (e.g., driver's typical energy consumption pattern such as aggressive driving, eco-driving mode, or mixed driving conditions, etc.), and determine an expected heat generation amount of the battery depending thereon.

In addition, the battery status determination unit 130 may determine whether a problem may occur in the operating performance of the vehicle, such as the driving performance associated with one or more batteries, power supply problems associated with the battery, battery life degradation, battery performance, etc.) of the vehicle 200 when the expected heat generation occurs based on the current temperature of the battery, the expected heat generation amount of the battery, external cooling efficiency (e.g., airflow around the battery during driving), and/or the expected power draw during acceleration events. In an example, power supply problems associated with the battery may include unstable power supply by the battery, insufficient power supply or power transfer from the battery. The battery performance may include various battery efficiency issues or battery performance issues, such as battery usage efficiency, battery consumption efficiency, etc.)

In addition, the battery status determination unit 130 may determine whether the current weather may further adversely affect the battery temperature during driving based on the current weather information received from the weather information server 300. For example, high ambient temperatures combined with high humidity may slow down battery cooling efficiency, while dry but hot conditions may accelerate heat dissipation.

Furthermore, the battery status determination unit 130 may determine whether the SoC of the battery will be sufficient to drive the vehicle 200 even if the coolant is cooled or if the battery undergoes pre-cooling, considering exemplary factors such as estimated cooling energy consumption, recent efficiency trends, and anticipated route elevation changes, etc.

One or more batteries of the vehicle may be cooled via one or more cooling mechanisms, (e.g., a coolant, one or more cooling pads attached to batterie(s), and/or cooled air, etc.).

Therefore, the battery status determination unit 130 may determine whether pre-cooling of the battery is desirable based on multiple factors, including but not limited to whether the vehicle 200 is expected to depart within a certain period of time from the present, the predicted battery temperature rise based on environmental conditions (e.g., ambient temperature, solar radiation, humidity, or wind speed, etc.), whether the expected heat generation of the battery (e.g., due to the driver's typical usage patterns such as frequent rapid acceleration, long-duration highway driving, or stop-and-go urban commuting, etc.) is expected to cause a problem in the driving performance, and whether the current weather is determined to further adversely affect the battery temperature during driving. For example, if high ambient temperatures combined with low wind speed and high humidity are detected, the battery status determination unit 130 may determine that natural cooling will be insufficient and initiate pre-cooling using external power from the charging station. Additionally, if the vehicle is in a region with frequent traffic congestion or high-altitude changes, where energy demands and heat buildup may be more significant, pre-cooling may be initiated.

The vehicle condition determination unit 150 may determine the average battery discharge energy per driving range based on driving pattern information of the driver of the vehicle 200, and determine an expected driving range based on the average battery discharge energy per driving range, the current SoE (State of Energy) of the battery, regenerative braking effectiveness, and/or expected auxiliary energy consumption (e.g., air conditioning, infotainment systems, or seat heaters) of the battery.

Here, the vehicle condition determination unit 150 may transmit a query on whether to perform battery preconditioning while providing the driver with information on the expected driving range and receive a response thereto.

In this specification, battery preconditioning means optimizing the status of the battery before driving the vehicle, which can improve driving efficiency. In addition, battery performance can be maintained even in environments such as extreme heat, extreme cold, or variable climate conditions such as frequent transitions between city traffic and high-speed highway driving.

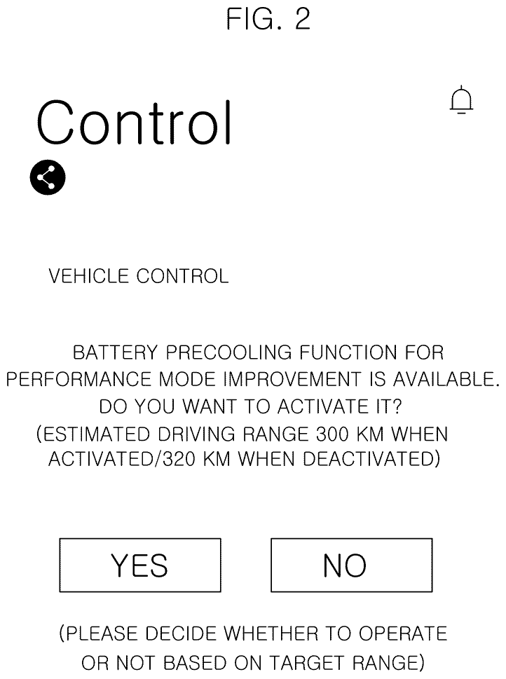

For example, the vehicle condition determination unit 150 may display a query such as “Battery precooling function for performance mode improvement is available. Do you want to activate it? (Yes/No)” on a display screen of the vehicle 200 or a driver terminal (not shown), as illustrated in FIG. 2, and receive a response thereto from the driver. The response may also include an option to customize the pre-cooling intensity based on energy availability or driving preferences (e.g., Eco Mode, Standard Mode, or Performance Mode).

Here, as the driver terminal, various terminals may be applied, such as a smartphone, a portable terminal, a mobile terminal, a foldable terminal, a personal digital assistant (PDA), a portable multimedia player (PMP) terminal, a telematics terminal, a navigation terminal, a personal computer, a notebook computer, a slate PC, a tablet computer, an ultrabook, a wearable device (including, for example, a smartwatch, a smart ring, a fitness band, a smart glass, a head mounted display (HMD), etc.), a WiBro terminal, an Internet protocol television (IPTV) terminal, a smart TV, a digital broadcasting terminal, an AVN (Audio Video Navigation) terminal, an A/V (Audio/Video) system, a flexible terminal, and a digital signage device. Additionally, integration with voice-assistant-enabled devices (e.g., Amazon Alexa, Google Assistant, or Apple Siri) may allow drivers to activate the pre-cooling function through voice commands.

The temperature optimization unit 170 may determine a target battery temperature before driving based on various data sources, including driving information of a group to which the driver belongs and battery information.

The driving information of the group to which the driver belongs may include a speed pattern, a rapid acceleration pattern, a driving mode, and a driving area.

The driving area may include an urban area (e.g., stop-and-go traffic, frequent braking, or lower-speed zones, etc.) and a highway area (e.g., high-speed cruising, fewer stops, or prolonged energy demand, etc.).

The battery information may include a battery output map and a predicted heat generation value, for example, based on real-time weather data, recent charging cycles, and/or historical driving trends.

For example, the temperature optimization unit 170 may determine an initial temperature of the battery based on driver's driving habits (e.g., the driver's historical energy consumption, preferred climate settings, and battery stress factors such as frequent fast charging, etc.) and a driving mode type (e.g., Eco Mode, Standard Mode, or Performance Mode).

For example, if the driver of the vehicle 200 usually enjoys low-speed fuel-efficient driving (e.g., frequently using regenerative braking, driving in urban environments, or maintaining steady speeds in city traffic, etc.) and does not tend to accelerate rapidly, the temperature optimization unit 170 may set the lowest temperature that can be achieved by a battery chiller as the initial temperature of the battery.

As another example, the temperature optimization unit 170 may set the lowest temperature among temperatures at which the battery can use the maximum discharge output as the initial temperature of the battery when the driver of the vehicle 200 usually enjoys high-speed fuel-efficient driving and tends to enjoy rapid acceleration and full acceleration (e.g., sport mode or aggressive overtaking), or uses high power output for towing or heavy loads.

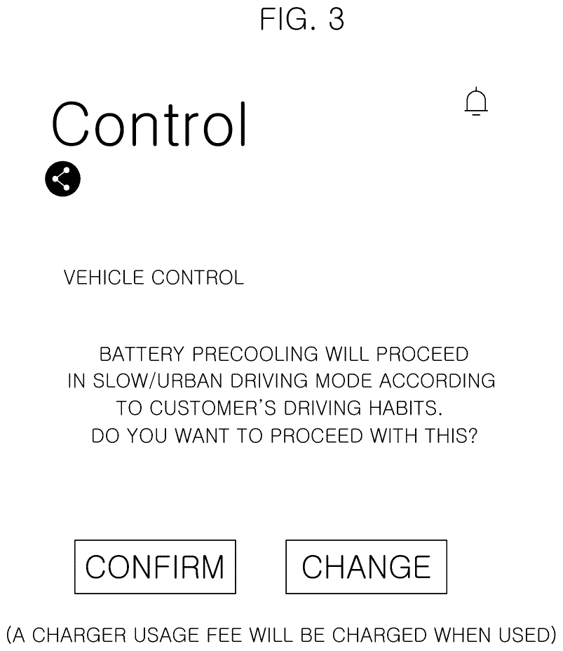

For example, the temperature optimization unit 170 may display a query such as “Battery precooling will proceed in slow/urban driving mode according to customer's driving habits. Do you want to proceed with this? (Yes/No)” on the display screen of the vehicle 200 or a driver terminal (not shown), as illustrated in FIG. 3, and receive a response thereto from the driver. Additionally or alternatively, the temperature optimization unit 170 may present alternative pre-cooling modes (e.g., Performance Mode, Energy-Saving Mode, or Adaptive Mode) based on historical driving behavior and external factors such as weather conditions and trip length.

In addition, the temperature optimization unit 170 may classify drivers of other vehicles with similar driving patterns and acceleration patterns into one group, analyze big data (e.g., aggregated telematics data), and modify the initial temperature of the battery before driving accordingly. For instance, drivers frequently using highway routes with high-speed cruising may be grouped separately from those primarily driving in stop-and-go city traffic. This classification may allow for more precise battery temperature management tailored to specific driving styles.

For example, the temperature optimization unit 170 may calculate and store energy efficiency metrics reflecting initial battery temperatures, initial SoCs, battery usage, average trip durations, ambient temperature exposure, charging frequency, and the like with respect to other drivers in the group to which the driver belongs, and determine an optimal initial battery temperature suitable for a driving pattern for each SoC based on the stored information. Additionally or alternatively, the temperature optimization unit 170 may refine its recommendations based on seasonal variations (e.g., summer vs. winter driving conditions) and/or specific battery characteristics.

In addition, the temperature optimization unit 170 may store information related to battery cooling based on driving information (e.g., information collected over time, including historical pre-cooling effectiveness, post-driving thermal retention trends, etc.) with respect to the group to which the driver belongs and battery information. The temperature optimization unit 170 may provide the information to battery manufacturers later such that they perform research on heat generation characteristics, etc. for real customers according to battery materials based on accumulated data. For example, the battery manufacturers may use the accumulated data to evaluate battery degradation patterns under different cooling strategies or adjust thermal management operations for future battery models. In addition, this information may be provided to automobile manufacturers such that cooling control of batteries, etc. for real customers can be studied based on accumulated data. For example, the automobile manufacturers may use pre-cooling efficiency data to adjust HVAC energy distribution strategies or optimize fan and coolant pump operation.

The driving information with respect to the group to which the driver belongs may include speed patterns (e.g., frequent acceleration and deceleration in urban areas, constant high-speed cruising on highways), rapid acceleration patterns (e.g., aggressive acceleration in sport mode, smooth acceleration in eco mode), driving modes (e.g., sport mode, Eco mode, normal mode, long-range mode, battery preconditioning mode, or highway mode, etc.), and driving areas (for example, urban areas or highway areas, congested city centers, suburban roads, rural highways, mountainous terrains, or desert regions where extreme heat may impact battery performance, etc.).

The battery information may include a battery output map and a real-time heat generation amount/estimate, for example, based on various operating conditions (e.g., high discharge rates during rapid acceleration, regenerative braking effects, ambient cooling efficiency, or power draw from auxiliary systems such as air conditioning and infotainment circuit, etc.).

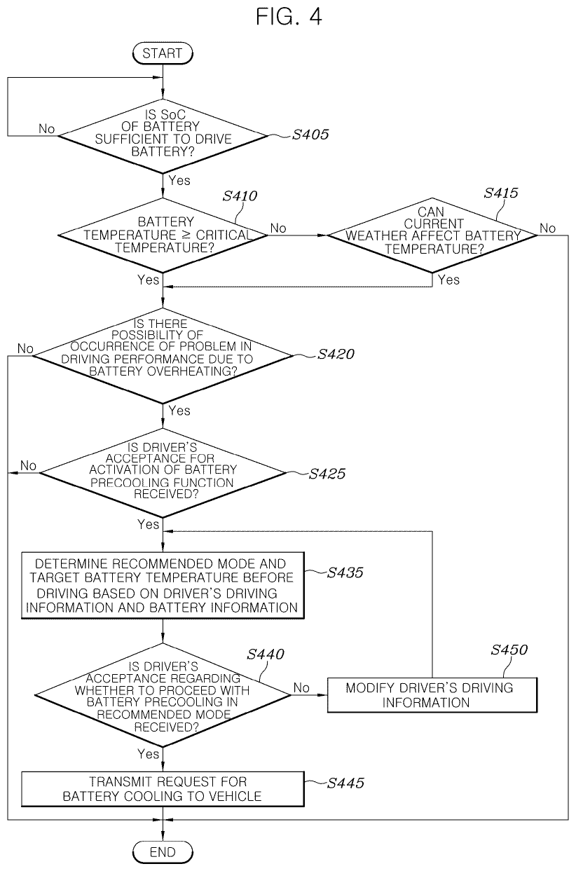

FIG. 4 shows an example of a battery temperature optimization method according to an example of the present disclosure.

The battery temperature optimization method according to the present example may be performed by the battery temperature optimization server 100 of FIG. 1.

Referring to FIG. 4, the battery temperature optimization server 100 may determine whether the state of charge (SoC) and/or state of energy (SoE) of the battery of the vehicle 200 will be sufficient to drive the vehicle 200 even if the battery undergoes a pre-cooling process that consumes energy (e.g., the coolant is cooled) (S405).

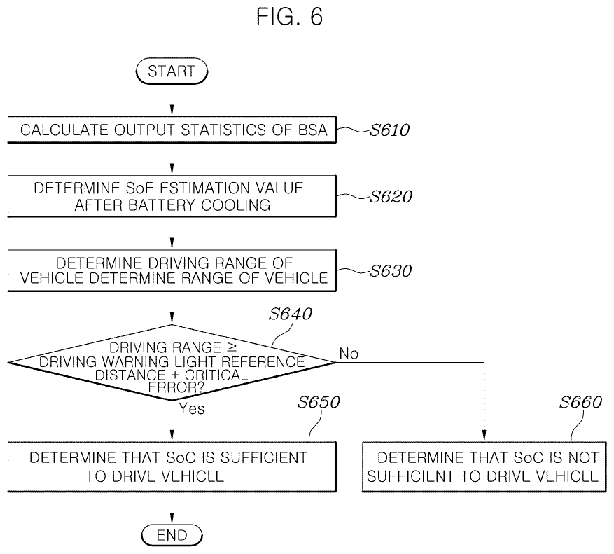

The specific process of step S405 will be described in detail below with reference to FIG. 6.

If the SoC of the battery is determined to be sufficient for the expected trip, the battery temperature optimization server 100 may determine whether the temperature of the battery is equal to or higher than a preset critical temperature (e.g., threshold temperature like 45° C., 50° C., or a dynamically adjusted limit based on battery chemistry and degradation history) (S410), and if the temperature of the battery is below the critical temperature, determine whether the current weather conditions (e.g., ambient temperature, humidity, solar radiation exposure, or wind speed, etc.) pose a risk of increasing battery temperature beyond a threshold level (S415).

Information on the temperature of the battery may be received in advance from the vehicle 200. For example, information on the temperature of the battery may be received from vehicle sensors, including a battery management system (BMS), thermal sensors embedded within battery modules, and/or external vehicle temperature sensors.

Information on the current weather may be received in advance from the weather information server 300 and/or other multiple sources. For example, the other multiple sources may comprise real-time vehicle telemetry from other vehicles in the area, satellite-based climate monitoring services, or roadside environmental sensors installed at charging stations, etc.

If it is determined that the temperature of the battery is equal to or higher than the preset temperature in step S410, or if it is determined that the current weather conditions could further contribute to battery overheating in step S415, the battery temperature optimization server 100 may determine whether a problem affecting vehicle performance, energy efficiency, or battery longevity may occur due to battery overheating caused by the driver's driving pattern (S420). For instance, the battery temperature optimization server 100 may assess whether the driver frequently engages in high-power demand scenarios (e.g., rapid acceleration, prolonged high-speed highway driving, or towing heavy loads), which could further elevate battery temperature and degrade performance. Conversely, in scenarios where the driver typically engages in energy-efficient behaviors (e.g., maintaining moderate speeds, using regenerative braking effectively, or preferring eco-driving modes), the risk of overheating may be lower, and pre-cooling may be deferred.

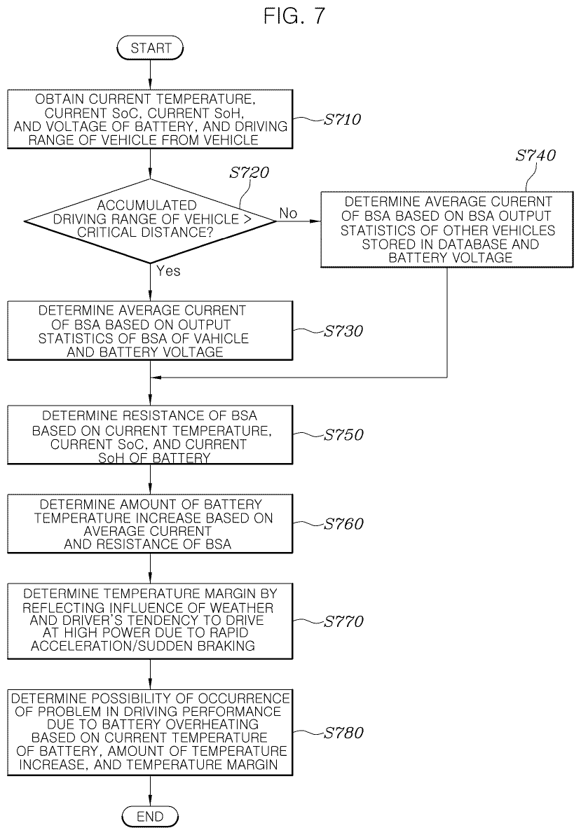

The specific process of step S420 will be described in detail below with reference to FIG. 7.

If it is determined that a problem may occur in the driving performance of the vehicle 200 due to battery overheating caused by the driver's driving pattern in step S420, it is determined whether the driver's acceptance for activation of the battery precooling function has been received (S425).

For example, the battery temperature optimization server 100 may display a query such as “Battery precooling function for performance mode enhancement is available. Do you want to activate it? (Yes/No)” on the display screen of the vehicle 200 or a driver terminal (not shown) (e.g., a smartphone, a tablet, a vehicle dashboard, a head-up display, an infotainment system, or a wearable device such as a smartwatch, etc.), as illustrated in FIG. 2, and receive a response thereto from the driver.

If it is determined that the driver's acceptance for activation of the battery precooling function has been received in step S425, a recommended mode and a target battery temperature before driving are determined based on the driver's driving information and battery information (S435).

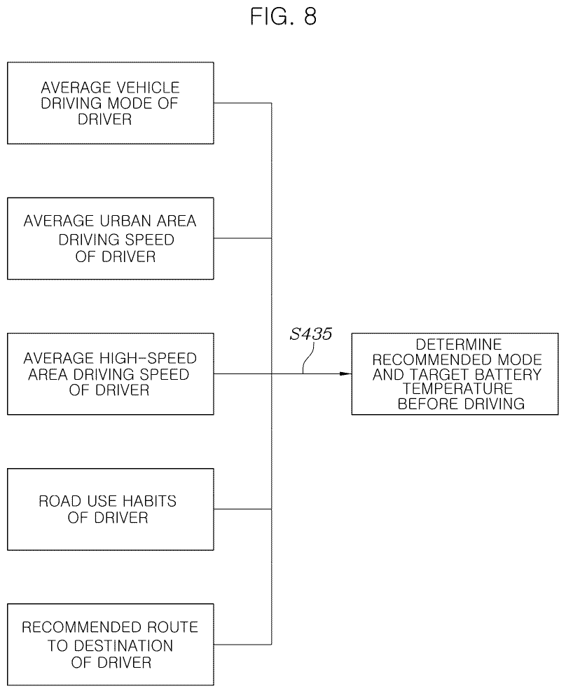

The specific process of the above step S435 will be described in detail below with reference to FIG. 8.

In addition, the battery temperature optimization server 100 may determine whether the driver's acceptance regarding the activation of precooling of the battery in the recommended mode has been received (S440).

For example, the battery temperature optimization server 100 may display a query such as “Precooling of the battery will proceed in the slow/urban driving mode according to customer's driving habits. Do you want to proceed with this? (Yes/No)” as an example of the recommended mode on the display screen of the vehicle 200 or the driver terminal (not shown) (e.g., a smartphone, a tablet, a vehicle dashboard, a head-up display, an infotainment system, or a wearable device such as a smartwatch, etc.), as illustrated in FIG. 3, and receive a response thereto from the driver.

If it is determined that the driver's acceptance for proceeding with precooling of the battery in the recommended mode has been received in step S440, the battery temperature optimization server 100 may transmit a request for battery cooling to the vehicle 200 (S445).

At this time, the request for battery cooling may include information on the recommended mode and the target battery temperature before driving (e.g., a sport mode with a target temperature, for example, 25° C., based on expected power demands for a relatively higher performance, an economy mode with a relatively lower target temperature, for example, 20° C., for energy efficiency, or normal mode with a balanced target temperature of 22° C., etc.).

If it is determined that the driver's acceptance for precooling of the battery in the recommended mode has not been received in step S440, the battery temperature optimization server 100 may modify the driver's driving information (S450) and determine a recommended mode and a target battery temperature before driving based on the driver's driving information and battery information (S435).

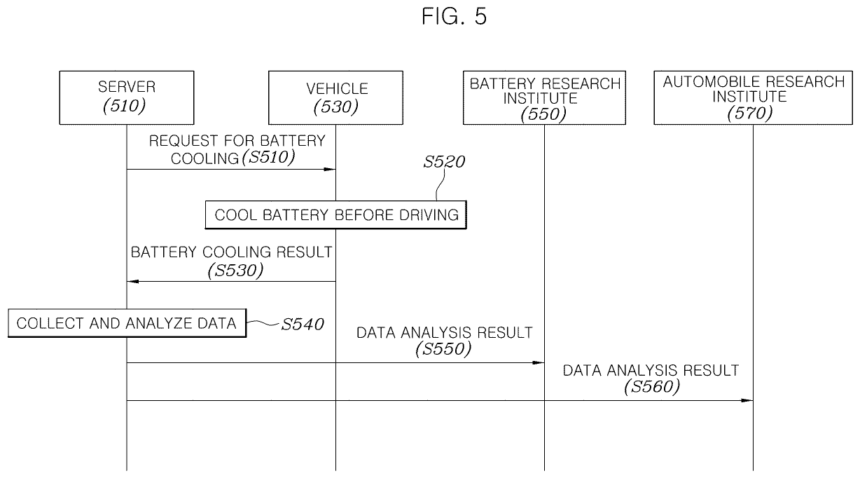

FIG. 5 shows an example of a signal transmission and reception relationship between a server, a vehicle, a battery research institute, and an automobile research institute according to an example of the present disclosure.

Referring to FIG. 5, when a server 510 transmits a request for battery cooling to the vehicle 530 (S510), the vehicle 530 may perform battery cooling before driving in response (S520) and transmit a battery cooling result to the server 510 (S530).

Upon receiving the battery cooling result from the vehicle 530 (S530), the server 510 may collect and analyzes data regarding the battery cooling result (S540) (e.g., battery temperature trends, cooling system efficiency, external environmental conditions, or energy consumption rates, etc.). By incorporating real-time data collection and feedback mechanisms, the server 510 may improve battery cooling strategies to enhance vehicle performance and battery longevity. Further, the server 510 may transmit a data analysis result to the battery research institute 550 and the automobile research institute 570 (S550 and S560). For example, the battery research institute 550 may use the data analysis result to evaluate battery performance under different cooling conditions (e.g., fast cooling, slow cooling, or passive cooling, etc.). For example, the automobile research institute 570 may analyze how the battery cooling results affect overall vehicle performance (e.g., acceleration response, driving range, power distribution efficiency, or thermal stability, etc.).

FIG. 6 shows an example of step S405 of FIG. 4 in detail.

Referring to FIG. 6, the battery temperature optimization server 100 may calculate output statistics of the battery system assembly (BSA) based on an average of power usage in urban areas and an average of power usage in highway areas of the vehicle 200 (S610).

The average of power usage in urban areas may be calculated based on an average power usage at or below an urban area standard speed and an average power usage at or above the urban area standard speed, considering factors such as traffic density, acceleration patterns, and stop-and-go frequency, etc., based on the speed of the vehicle.

The urban area standard speed may be set to, for example, 60 km/h (e.g., 40 km/h, 50 km/h, 55 km/h, or 65 km/h, etc.).

The average of power usages in highway areas may be calculated based on an average power usage at or below a highway area standard speed and an average power usage at or above the highway area standard speed, considering factors such as aerodynamic drag, elevation changes, and cruise control usage, etc., based on the speed of the vehicle.

The highway area standard speed may be set to, for example, 80 km/h (e.g., 70 km/h, 90 km/h, 100 km/h, or 110 km/h, etc.).

In addition, the battery temperature optimization server 100 may deduct a predicted energy usage value during precooling operation from the SoE of the battery management system (BMS) to determine an SoE estimation value after the battery is cooled (S620). This predicted energy usage value may depend on factors such as ambient temperature, cooling system efficiency, battery age, or recent charge/discharge cycles, etc.

In addition, the battery temperature optimization server 100 may determine a driving range of the vehicle 200 based on the output statistics of the BSA and the SOE estimation value after the battery is cooled (S630). For example, the driving range may be adjusted considering real-time traffic conditions, regenerative braking contributions, or recent driving habits, etc.

In addition, the battery temperature optimization server 100 may determine whether the driving range is greater than a value obtained by adding a critical error to a driving warning light reference distance (S640). If the driving range is greater than the value, the battery temperature optimization server 100 may determine that the SoC of the battery of the vehicle 200 will be sufficient to drive the vehicle 200 even if the battery undergoes pre-cooling (e.g., the coolant is cooled).

The driving warning light reference distance may indicate a distance that the vehicle can travel until the battery warning light is turned on when the vehicle is driven with the current SoC. This distance may vary based on external factors such as road gradient, tire pressure, and battery discharge efficiency, etc.

The critical error may be any value and may be set to, for example, 5% of the driving warning light reference distance (e.g., 3%, 4%, 6%, or 7%, etc.).

In addition, if the driving range is not greater than the value obtained by adding the critical error to the driving warning light reference distance, the battery temperature optimization server 100 may determine that the SoC of the battery of the vehicle 200 will not be sufficient to drive the vehicle 200 if the battery undergoes pre-cooling (e.g., the coolant is cooled). In such cases, the system may suggest alternative measures, such as adjusting the cooling intensity, delaying precooling until charging, or prioritizing essential cooling functions to prevent energy drain, etc.

FIG. 7 shows an example of step S420 of FIG. 4 in detail.

Referring to FIG. 7, the battery temperature optimization server 100 may obtain the current temperature, the current SoC, the current SoH (State of Health), and the voltage of the battery, and the accumulated driving range of the vehicle from the vehicle 200 (S710).

In addition, the battery temperature optimization server 100 may determine whether the accumulated driving range of the vehicle 200 is greater than a critical distance (S720). If the driving range of the vehicle 200 is greater than the critical distance, the battery temperature optimization server 100 may determine the average current of the battery system assembly (BSA) based on the output statistics (e.g., historical driving patterns, environmental conditions, etc.) of the vehicle and the voltage of the battery (S730).

The critical distance may be a significant statistical value, and may be set to, for example, 1000 km, 800 km, 1,200 km, 1,500 km, or 2,000 km, etc. The output statistics of the BSA may be determined based on an average of power usage in urban areas and an average of power usage in highway areas of the vehicle 200.

The average of power usage in urban areas may be calculated based on an average power usage at or below an urban area standard speed and the average power usage at or above the urban area standard speed (e.g., considering factors such as traffic congestion, stop duration, and acceleration frequency, etc.) based on the vehicle speed.

The urban area standard speed may be set to, for example, 60 km/h, 50 km/h, 55 km/h, 65 km/h, or 70 km/h, etc. The average of power usage in highway areas may be calculated based on an average power usage at or below a highway area standard speed and an average power usage at or above the highway area standard speed (e.g., considering factors such as wind resistance, gradient variations, and lane-changing frequency, etc.) based on the vehicle speed.

The highway area standard speed may be set to, for example, 80 km/h, 90 km/h, 100 km/h, 110 km/h, or 120 km/h, etc.

If it is determined that the driving range of the vehicle 200 is not greater than the critical distance in step S720, the battery temperature optimization server 100 may determine the average current of the BSA based on BSA output statistics of other vehicles stored in the database (not shown) and the voltage of the battery (S740). These statistics may include variations in load demand, battery degradation rates, or charging cycle histories, etc.

In addition, the battery temperature optimization server 100 may determine the resistance of the BSA based on the current temperature, the current SoC, the current SoH of the battery, and/or other factors (S750). For example, other factors may include internal impedance changes, electrolyte conductivity variations, or cell aging effects, etc.

In addition, the battery temperature optimization server 100 may determine the amount of battery temperature increase based on the average current of the BSA and the resistance of the BSA (S760). The amount of battery temperature increase may be influenced by factors such as ambient cooling efficiency, ventilation effectiveness, or thermal runaway potential, etc.

In addition, the battery temperature optimization server 100 may determine a temperature margin by reflecting an influence of weather and a driver's tendency to drive at high power due to rapid acceleration/sudden braking (S770). For example, adverse weather conditions such as extreme heat, humidity, or cold may affect cooling performance, while aggressive driving behavior may lead to increased heat generation.

The influence of weather may be determined based on weather information received from the weather information server 300.

The driver's tendency to drive at high power due to rapid acceleration/sudden braking may be determined based on a reference factor calculated according to the mathematical expression 1 below.

$$[ Mathematical expression 1 ]$$

$$Reference factor = ( number of occurrences of speed changes of 10 kph or more per second per 100 km of driving range ) * duration * average power when speed changes occur$$

In addition, the battery temperature optimization server 100 may determine the possibility of a driving performance problem due to battery overheating based on the current temperature of the battery, the amount of battery temperature increase, and the temperature margin (S780). If the possibility of overheating is high, the battery temperature optimization server 100 may take alternative measures, such as dynamically controlling cooling intensity, adjusting power distribution strategies, or preemptively adjusting battery load to mitigate excessive heat generation, etc.

FIG. 8 shows an example of step S435 of FIG. 4 in more detail.

Referring to FIG. 8, the battery temperature optimization server 100 may determine a recommended mode and a target battery temperature before driving based on an average vehicle driving mode of the driver, an average urban area driving speed of the driver, an average high-speed area driving speed of the driver, road use habits of the driver, and a recommended route to a destination of the driver (S435). These factors may also consider additional elements, such as historical driving efficiency, weather conditions, or traffic congestion trends, etc.

Vehicle driving modes may include, for example, a sport mode, an eco mode, comfort mode, off-road mode, long-range mode, battery preconditioning mode, highway mode, or adaptive mode, etc.

Whether an area is an urban area or not may be determined based on a global positioning system (GPS), and the average urban area driving speed of the driver may be calculated by measuring only speeds of, for example, 30 kph or more in the urban area and averaging the same. This calculation may further incorporate stop-and-go frequency, acceleration behavior, or time-of-day variations, etc.

The average urban area driving speed may also be calculated as a ratio of a driving speed to a speed limit.

Whether an area a high-speed area or not may be determined based on a GPS, and the average high-speed area driving speed of the driver may be calculated by measuring only speeds of, for example, 60 kph or more on highway, expressways, or national roads and averaging the same. Additional considerations may include lane selection, overtaking frequency, or adherence to traffic flow patterns, etc.

The average high-speed area driving speed may also be calculated as a ratio of a driving speed to a speed limit, factoring in seasonal speed adjustments, road work zones, or automated enforcement areas, etc.

The road usage habits of the driver may be determined based on whether they prefer a free road or a toll road. For example, additional preferences may include route selection based on fuel efficiency, scenic routes, or avoidance of high-traffic areas, etc. For example, a driver who frequently avoids toll roads may be determined to prioritize cost savings and may tend to drive at lower speeds to maximize fuel efficiency. In contrast, a driver who consistently chooses toll roads may be determined to prioritize reduced travel time and may tend to drive at higher speeds, accelerate more aggressively, and maintain speeds closer to the speed limit to reach their destination faster.

It is another object of the present disclosure to optimize a battery temperature of an eco-friendly vehicle left unattended in the summer to improve driving performance.

The technical objects to be achieved in the present disclosure are not limited to the technical objects mentioned above, and other technical objects that are not mentioned can be clearly understood by those skilled in the art from the description below.

In accordance with an aspect of the present disclosure, the above and other objects can be accomplished by the provision of a method of optimizing a battery temperature, including determining whether a state of charge (SoC) of a battery before driving a vehicle is sufficient to drive the vehicle, determining whether there is a possibility of driving performance of the vehicle being affected by overheating of the battery if the SoC is sufficient to drive the vehicle, determining a recommended mode and a target battery temperature before driving based on driving information of a driver and battery information if there is a possibility of the driving performance of the vehicle being affected, and transmitting a request for battery cooling to the vehicle.

Here, the determining whether there is a possibility of driving performance of the vehicle being affected by overheating of the battery may include determining whether there is a possibility of the driving performance of the vehicle being affected by overheating of the battery when a temperature of the battery is equal to or higher than a critical temperature or current weather is able to affect the temperature of the battery.

Here, the determining whether an SoC of a battery before driving a vehicle is sufficient to drive the vehicle may include calculating output statistics of a battery system assembly (BSA), determining a state of energy (SoE) estimation value after cooling the battery by deducting a predicted energy usage value during precooling operation from an SoE of a battery management system (BMS), determining a driving range of the vehicle based on the output statistics of the BSA and the SoE estimation value after cooling the battery, and determining whether the SoC of the battery before driving the vehicle is sufficient to drive the vehicle based on the driving range of the vehicle.

Here, the output statistics of the BSA may be calculated based on an average of power usage in urban areas and an average of power usage in highway areas of the vehicle.

Here, the average of power usage in urban areas may be determined based on an average power usage at or below an urban area standard speed and an average power usage at or above the urban area standard speed based on a speed of the vehicle.

Here, the average of power usage in highway areas may be determined based on an average power usage at or below a highway area standard speed and an average power usage at or above the highway area standard speed based on the speed of the vehicle.

Here, the determining a recommended mode and a target battery temperature before driving may include
determining a resistance of the BSA based on a current temperature, a current SoC, and a current SoH of the battery, determining an amount of battery temperature increase based on an average current of the BSA and the resistance of the BSA, determining a temperature margin by reflecting an influence of weather and a driver's tendency to drive at high power due to rapid acceleration/sudden braking, and determining a possibility of a driving performance problem due to battery overheating based on the current temperature of the battery, the amount of temperature increase, and the temperature margin.

Here, the recommended mode and the target battery temperature before driving may be determined based on at least one of an average vehicle driving mode of the driver, an average urban area driving speed of the driver, an average highway area driving speed of the driver, road use habits of the driver, or a recommended route to a destination of the driver.

In accordance with another aspect of the present disclosure, there is provided a battery temperature optimization server including a battery status determination unit configured to determine whether a state of charge (SoC) of a battery before driving a vehicle is sufficient to drive the vehicle, a vehicle condition determination unit configured to determine whether there is a possibility of driving performance of the vehicle being affected by overheating of the battery if the SoC is sufficient to drive the vehicle, a battery optimization unit configured to determine a recommended mode and a target battery temperature before driving based on driving information of a driver and battery information if there is a possibility of the driving performance of the vehicle being affected, and a transmission unit configured to transmit a request for battery cooling to the vehicle.

Here, the vehicle condition determination unit may be configured to determine whether there is a possibility of the driving performance of the vehicle being affected by overheating of the battery when a temperature of the battery is equal to or higher than a critical temperature or current weather is able to affect the temperature of the battery.

Here, the battery status determination unit may be configured to calculate output statistics of a battery system assembly (BSA), determine a state of energy (SoE) estimation value after cooling the battery by deducting a predicted energy usage value during precooling operation from an SoE of a battery management system (BMS), determine a driving range of the vehicle based on the output statistics of the BSA and the SoE estimation value after cooling the battery, and determine whether the SoC of the battery before driving the vehicle is sufficient to drive the vehicle based on the driving range of the vehicle.

Here, the output statistics of the BSA may be calculated based on an average of power usage in urban areas and an average of power usage in highway areas of the vehicle.

Here, the average of power usage in urban areas may be determined based on an average power usage at or below an urban area standard speed and an average power usage at or above the urban area standard speed based on a speed of the vehicle.

Here, the average of power usage in highway areas may be determined based on an average power usage at or below a highway area standard speed and an average power usage at or above the highway area standard speed based on the speed of the vehicle.

Here, the temperature optimization unit may be configured to determine a resistance of the BSA based on a current temperature, a current SoC, and a current SoH of the battery, determine an amount of battery temperature increase based on an average current of the BSA and the resistance of the BSA, determine a temperature margin by reflecting an influence of weather and a driver's tendency to drive at high power due to rapid acceleration/sudden braking, and determine a possibility of a driving performance problem due to battery overheating based on the current temperature of the battery, the amount of temperature increase, and the temperature margin.

Here, the recommended mode and the target battery temperature before driving may be determined based on at least one of an average vehicle driving mode of the driver, an average urban area driving speed of the driver, an average highway area driving speed of the driver, road use habits of the driver, or a recommended route to a destination of the driver.

According to the examples of the present disclosure described above, a high battery temperature can be optimized in advance before driving a vehicle in consideration of a driving pattern or preference of a driver.

In addition, the driving performance can be improved by optimizing the battery temperature of an eco-friendly vehicle left unattended in the summer.

The effects that can be obtained from the present disclosure are not limited to the effects mentioned above, and other effects not mentioned can be clearly understood by those skilled in the art from the description below.

The above-described present disclosure can be implemented as computer-readable code on a medium in which a program is recorded. Computer-readable media includes all types of recording devices that store data that can be read by a computer system. Examples of computer-readable media include a hard disk drive (HDD), a solid state drive (SSD), a silicon disk drive (SDD), a ROM, a RAM, a CD-ROM, a magnetic tape, a floppy disk, an optical data storage device, etc. Accordingly, the above detailed description should not be construed as restrictive in all respects and should be considered illustrative. The scope of the present disclosure should be determined by reasonable interpretation of the appended claims, and all changes within the equivalent scope of the present disclosure are included in the scope of the present disclosure.

What is claimed:

1. A method performed by an apparatus configured to communicate with a vehicle comprising:
before driving the vehicle, determining, by the apparatus, whether a state of charge (SoC) of a battery of the vehicle satisfies a threshold SoC value;
based on a determination that the SoC of the battery satisfies the threshold SoC value, determining, by the apparatus, an indicator indicating a predicted operating performance of the vehicle associated with overheating of the battery;
based on driving information of a driver of the vehicle, battery information, and the indicator, generating a signal indicating a recommended mode of the vehicle and a target battery temperature of the battery; and
transmitting the signal to the vehicle.

2. The method of claim 1, wherein the determining the indicator comprises determining, based on a temperature of the battery being equal to or higher than a threshold temperature or based on a reference temperature associated with a current weather condition, the indicator indicating the predicted operating performance of the vehicle associated with overheating of the battery.

3. The method of claim 1, wherein the determining whether the SoC of the battery of the satisfies the threshold SoC value comprises:
determining output statistics associated with the battery;
determining a state of energy (SoE) estimation value of the battery after cooling the battery by deducting a predicted energy usage value during cooling operation from a measured SoE associated with the battery;
determining a driving range of the vehicle based on the output statistics and the SoE estimation value after cooling the battery; and
before driving the vehicle, determining, based on the driving range of the vehicle, whether the SoC of the battery is sufficient to drive the vehicle.

4. The method of claim 3, wherein the output statistics are determined based on an average of power usage of the vehicle operating in urban areas and an average of power usage of the vehicle operating in highway areas.

5. The method of claim 4, wherein the average of power usage in urban areas is determined based on:
an average power usage of the vehicle operating at or below an urban area standard speed, and
an average power usage of the vehicle operating at or above the urban area standard speed.

6. The method of claim 4, wherein the average of power usage in highway areas is determined based on:
an average power usage of the vehicle operating at or below a highway area standard speed, and
an average power usage of the vehicle operating at or above the highway area standard speed.

7. The method of claim 1, wherein the generating the signal comprises:
determining a resistance associated with the battery based on a current temperature of the battery, a current SoC of the battery, and a current state of health (SoH) of the battery;
determining an amount of battery temperature increase based on an average current associated with the battery and the resistance associated with the battery;
determining a temperature margin based on weather conditions and driving habits of the driver of the vehicle, wherein the driving habits are associated with an acceleration of the vehicle; and
determining the indicator indicating the predicted operating performance of the vehicle associated with overheating of the battery based on the current temperature of the battery, the amount of battery temperature increase, and the temperature margin.

8. The method of claim 1, wherein the recommended mode and the target battery temperature, before driving the vehicle, are determined based on at least one of:
an average driving mode of the driver,
an average driving speed of the driver when the driver is driving in urban areas,
an average driving speed of the driver when the driver is driving in highway areas,
road usage habits of the driver, or
a recommended route for a destination set by the driver.

9. An apparatus configured to communicate with a vehicle, the apparatus comprising:
a processor; and
a memory storing at least one instruction that, when executed by the processor communicating with the memory, is configured to cause the apparatus to:
before driving the vehicle, determine whether a state of charge (SoC) of a battery of a vehicle satisfies a threshold SoC value;
determine, based on a determination that the SoC of the battery satisfies the threshold SoC value, an indicator indicating a prediction of a predicted operating performance of the vehicle associated with overheating of the battery;
based on driving information of a driver of the vehicle, battery information, and the indicator, generate a signal indicating a recommended mode of the vehicle and a target battery temperature of the battery; and
transmit the signal to the vehicle.

10. The apparatus of claim 9, wherein the at least one instruction, when executed by the processor communicating with the memory, is configured to cause the apparatus to determine, based on a temperature of the battery being equal to or higher than a threshold temperature or based on a reference temperature associated with a current weather condition, the predicted operating performance of the vehicle associated with overheating of the battery.

11. The apparatus of claim 9, wherein the at least one instruction, when executed by the processor communicating with the memory, is configured to cause the apparatus to:
determine output statistics associated with the battery;
determine a state of energy (SoE) estimation value of the battery after cooling the battery by deducting a predicted energy usage value during cooling operation from a measured SoE associated with the battery;
determine a driving range of the vehicle based on the output statistics and the SoE estimation value after cooling the battery; and
before driving the vehicle, determine, based on the driving range of the vehicle, whether the SoC of the battery is sufficient to drive the vehicle.

12. The apparatus of claim 11, wherein the output statistics are determined based on:
an average of power usage of the vehicle operating in urban areas, and
an average of power usage of the vehicle operating in highway areas.

13. The apparatus of claim 12, wherein the average of power usage of the vehicle operating in urban areas is determined based on:
an average power usage of the vehicle operating at or below an urban area standard speed, and
an average power usage of the vehicle operating at or above the urban area standard speed.

14. The apparatus of claim 12, wherein the average of power usage in highway areas is determined based on:
an average power usage of the vehicle operating at or below a highway area standard speed, and
an average power usage of the vehicle operating at or above the highway area standard speed.

15. The apparatus of claim 9, wherein the at least one instruction, when executed by the processor communicating with the memory, is configured to cause the apparatus to:
determine a resistance associated with the battery based on a current temperature of the battery, a current SoC of the battery, and a current state of health (SoH) of the battery;
determine an amount of battery temperature increase based on an average current associated with the battery and the resistance associated with the battery;
determine a temperature margin based on an weather conditions and driving habits of the driver of the vehicle, wherein the driving habits are associated with an acceleration of the vehicle; and
determine the indicator indicating the predicted operating performance of the vehicle associated with overheating of the battery based on the current temperature of the battery, the amount of battery temperature increase, and the temperature margin.

16. The apparatus of claim 9, wherein the recommended mode and the target battery temperature, before driving the vehicle, are determined based on at least one of:
an average driving mode of the driver,
an average driving speed of the driver when the driver is driving in urban areas,
an average driving speed of the driver when the driver is driving in highway areas,
road usage habits of the driver, or
a recommended route for a destination set by the driver.

17. A method performed by an apparatus of a vehicle comprising:
transmitting, to a device, data associated with the vehicle, wherein the data comprises a state of charge (SoC) of a battery of the vehicle and a temperature of the battery;
determining, based on a battery cooling condition being satisfied, an operation mode of the vehicle and a target temperature of the battery;
adjusting, based on the target temperature, the temperature of the battery before driving the vehicle; and
driving the vehicle based on the operation mode after the temperature of the battery reaches the target temperature.

18. The method of claim 17, wherein the operation mode comprises one of a sport mode, an eco mode, an off-road mode, a long-range mode, or a highway mode.

19. The method of claim 17, further comprising receiving, from a connected charger, power for charging the battery and cooling the battery until the temperature of the battery reaches the target temperature.

20. The method of claim 17, wherein the battery cooling condition comprises at least one of:
a user permission for cooling the battery using power supplied from a connected charger;
the operation mode of the vehicle; or
driving habits of a driver of the vehicle.
